(19) United States
(12) Patent Application Publication
(10) Pub. No.: US 2009/0210382 A1
(43) Pub. Date: Aug. 20, 2009

(54) METHOD FOR PRIORITY SEARCH USING A TCAM

(76) Inventors: ELIEL LOUZOUN, Jerusalem (IL); Ben-Zion Friedman, Jerusalem (IL)

Correspondence Address: Larry Mennemeier;Intel Corporation, c/o Intellevate, LLC, P.O. Box 52050, Minneapolis, MN, 55402, US

(21) Appl. No.: 12/032,425

(22) Filed: Feb. 15, 2008

(51) Int. Cl. G06F 7/06

(52) U.S. Cl. 707/3; 707/E17.108

(57) ABSTRACT

Methods and apparatus are disclosed for searching prioritized content using a ternary content-addressable memory (TCAM). Data strings and corresponding priorities are stored at indexed storage locations in a TCAM. The priorities for the corresponding data strings are unsorted with respect to the indices of the indexed storage locations. The TCAM is searched using input data including an input string, an input mask, an input priority and a priority mask. The number of searches is no more than the number of possible distinct priorities—in some embodiments no more than the logarithm of the number of possible priorities. A match index is output corresponding to a storage location that has a matching string selected according to the input mask and also has an optimal priority.

### FIELD OF THE DISCLOSURE

This disclosure relates generally to the field of networking. In particular, the disclosure relates to searching prioritized content using a ternary content-addressable memory (TCAM).

### BACKGROUND OF THE DISCLOSURE

Network devices such as routers, switches or controllers often make use of content-addressable memory (CAM). A CAM is a special type of memory that in some ways operates in the opposite way as random-access memory (RAM) operates. With RAM the system provides an address, and receives data stored at the address. With a CAM, the system supplies the data, and the CAM returns a list of addresses or indices where the data is stored, if any are found. CAMs can search the entire memory in one operation, so they are considerably faster to use than RAM and they are also more expensive.

The most commonly used CAMs are called binary CAMs. They search only for ones and zeros. Media access control (MAC) address tables in switches commonly get stored in binary CAMs. For a switch to be capable of forwarding Ethernet frames at line-speed gigabit, typically it would employ CAMs for lookups. In such a case the particular switchport that data should be sent out is retrieved from the CAM based on a given MAC address.

A TCAM is a ternary CAM, which allows the operating system to match a third state, “X.” The X state is a “mask,” meaning its value can be anything. Masks are particularly useful in networking, for example, because netmasks operate this way. To calculate a subnet address one masks the bits that don't matter, and applies a logical AND operation to the rest. Routers can store their entire routing table in TCAMs, allowing for very quick lookups.

In some cases content may also have associated priorities. Packets may be queued according to various priority schemes, e.g. to provide quality of service (QOS). Internet protocol (IP) forwarding is another such application where the longest prefix match is sought. In cases such as these it may be desirable to quickly lookup the highest priority matching content from a list of matching content in a memory.

Longest prefix match searches could be completed in one cycle, provided that entries in the TCAM are ordered such that the longest prefixes are stored at lower addresses as a TCAM returns the matching entry residing at the lowest address. However, a need to maintain a sorted table makes any incremental updates a difficult and/or time consuming problem. To date, potential solutions to such priority searches have not been adequately explored.

### BRIEF DESCRIPTION OF THE DRAWINGS

The present invention is illustrated by way of example and not limitation in the figures of the accompanying drawings.

FIG. 1 illustrates one embodiment of an apparatus to search prioritized content using a ternary content-addressable memory (TCAM).

FIG. 2 illustrates a flow diagram for one embodiment of a process to search prioritized content using a TCAM.

FIG. 3 illustrates a flow diagram for an alternative embodiment of a process to search prioritized content using a TCAM.

### DETAILED DESCRIPTION

Methods and apparatus are disclosed for searching prioritized content using a ternary content-addressable memory (TCAM). Data strings and corresponding priorities are stored at indexed storage locations in a TCAM. The priorities for the corresponding data strings are unseated with respect to the indices of the indexed storage locations. The TCAM is searched using input data including an input string, an input mask, an input priority and a priority mask. The number of searches is no more than the number of possible distinct priorities—in some embodiments no more than the logarithm of the number of possible priorities. A match index is output corresponding to a storage location that has a matching string selected according to the input mask and is also associated with an optimal priority value. Thus, where the number of priority values may be predetermined the number of searches may be bounded by a small constant.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims and their equivalents.

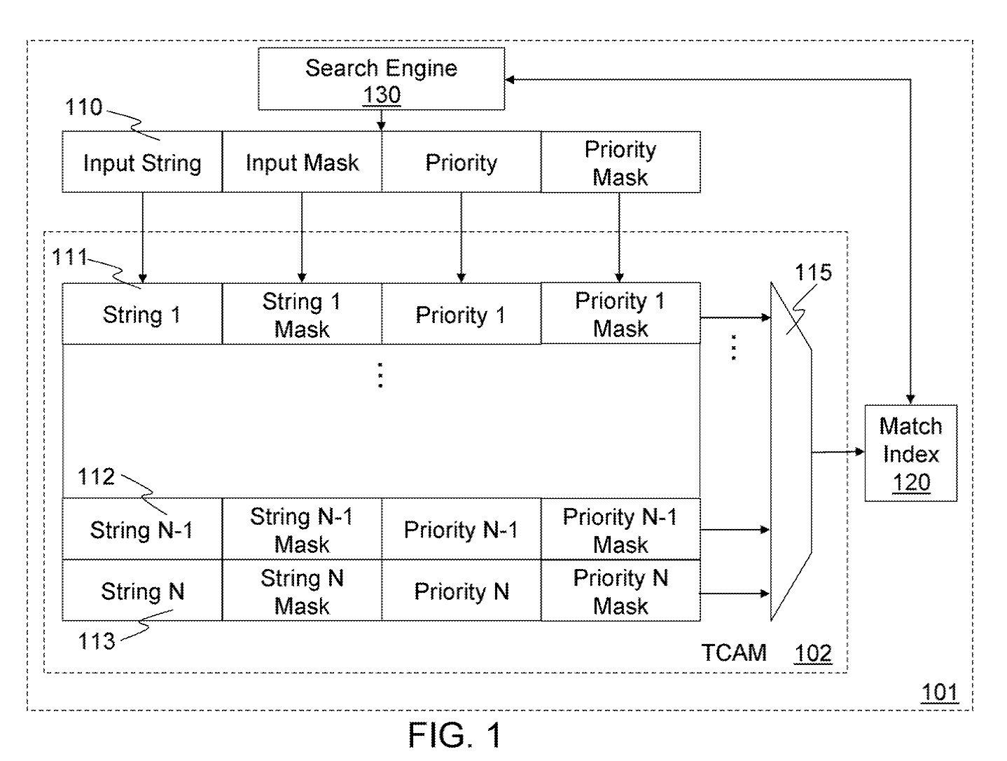

FIG. 1 illustrates one embodiment of an apparatus 101 to search prioritized content using a TCAM 102. TCAM 102 stores a number of unsorted data strings 1-N and corresponding unsorted priority values 1-N at a corresponding number of indexed storage locations 111-113. That is to say, the priority values and the corresponding data strings are unsorted with respect to the indices of the indexed storage locations.

Search engine 130 searches the TCAM 102 using various input data 110 including an input string, an input mask, an input priority value and a priority mask. In some embodiments of input data 110 and TCAM 102, the priority mask may be capable of masking only a restricted subset of the input priority value. In some embodiments the priority mask bits in TCAM 102 may all be set to one (1) so that they are always part of the comparison. When any matches occur among the indexed storage locations 111-113 storing data strings that match the portion of the input string selected according to the input mask and storing priorities that match the portion of the input priority selected according to the priority mask, encoder 115 outputs a match index 120.

Search engine 130 determines when match index 120 corresponds to one of the indexed storage locations 111-113 that is also storing an optimal priority value. Search engine 130 then outputs that particular match index upon making an affirmative determination. Search engine 130 may comprise dedicated hardware or software or firmware operation codes executable by general purpose machines or by special purpose machines or by a combination of both. As will be explained in greater detail below, the number of searches using various input data 110 is no more than the number of distinct valid priority values, k, which may typically be small in comparison with the number of indexed storage locations. A linear search, for example, would provide such an upper bound on searching. Some embodiments of search engine 130, for example using a binary search, perform no more than log₂ (k+1) searches in making such a determination. Alternative embodiments of search engine 130 may perform a smaller number of searches for optimal priority values, for example as in a linear search or a hybrid combination of a linear search and a binary search. Since the number of possible distinct priority values may be predetermined, the number of searches performed by search engine 130 is effectively bounded by a small constant value.

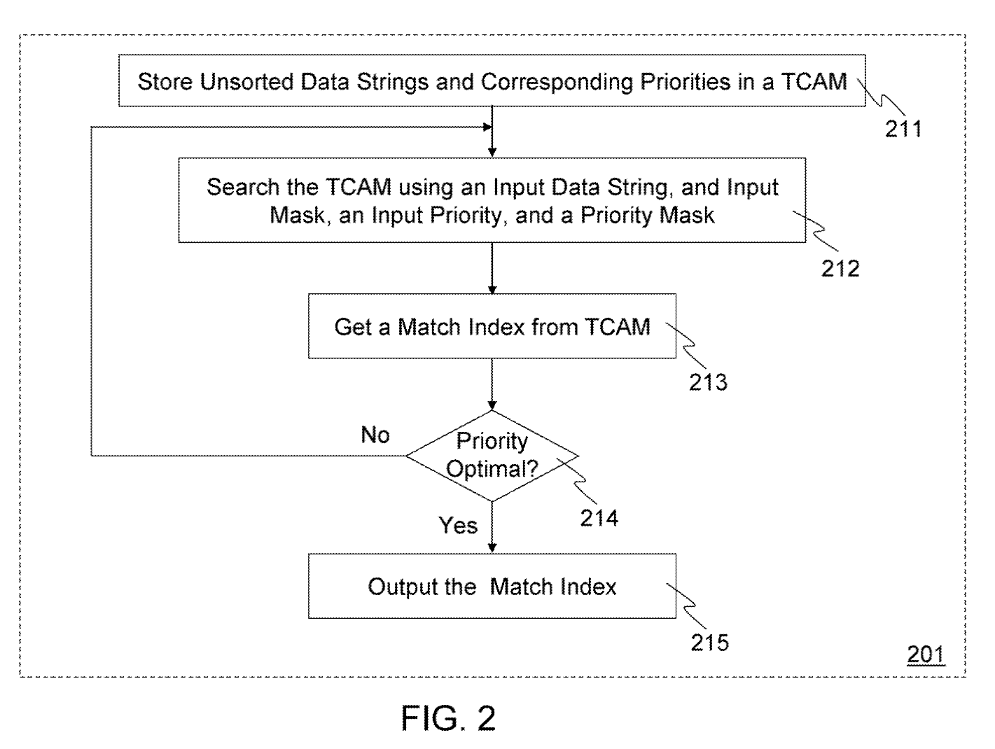

FIG. 2 illustrates a flow diagram for one embodiment of a process 201 to search prioritized content using a TCAM. Process 201 and other processes herein disclosed are performed by processing blocks that may comprise dedicated hardware or software or firmware operation codes executable by general purpose machines or by special purpose machines or by a combination of both.

In processing block 211 a number of unsorted data strings and corresponding unsorted priority values are stored at a corresponding number of indexed storage locations in a TCAM. In other words, priority values for the corresponding data strings are unsorted with respect to the indices of the indexed storage locations. Thus the TCAM will not necessarily output match index associated with an optimal priority.

Using an input data that includes an input data string, an input mask, an input priority value and a priority mask, the TCAM is searched in processing block 212. A match index is retrieved from the TCAM in processing block 213. Then in processing block 214 the match index is checked to determine if it is associated with an optimal priority. If it is optimal, then the match index is output in processing block 215. Otherwise, processing continues in processing block 212 wherein the input priority value and priority mask are adjusted for another search.

It will be appreciated that if the number of possible priority values is k, then the number of searches required is no more than the number k, which typically is significantly less than number of indexed storage locations. In one embodiment, a binary search using combinations of the input priority value and the priority mask requires no more than log₂ k+1 searches. For example, if eight possible priorities (0-7) are representable, then searching first for a priority value of 1XX, and then searching for a priority value of 11X on a match, or for a priority value of 01X otherwise, and so on . . . will find an optimal match (if any match exists) in four TCAM searches. It will be appreciated that when there is more than one match having the same priority value, the one match index produced by the TCAM may be used as output.

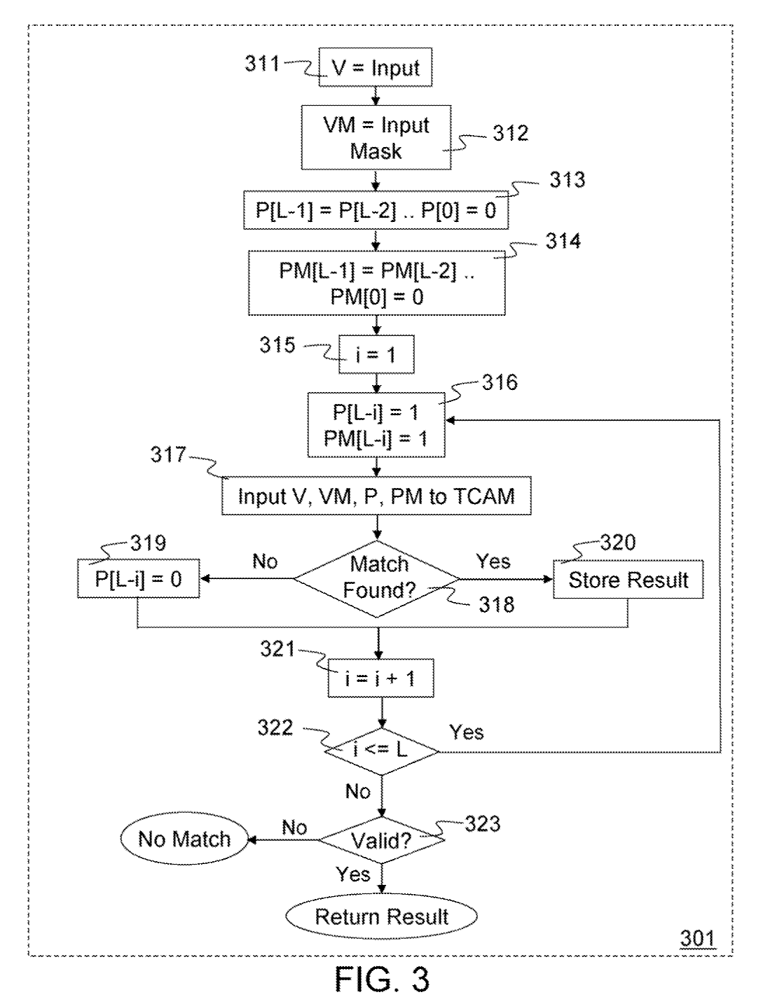

FIG. 3 illustrates a flow diagram for an alternative embodiment of a process 301 to search prioritized content using a TCAM. In process 301, a length, L, for priorities permits 2^{L}−1 valid priorities (i.e. 1 to 2^{L}−1), zero representing an invalid priority.

In processing block 311 V is set to the value of an input data string, and in processing block 312 VM is set to the value of an input mask. In processing block 313 P[i] is initialized to zero (0) for each bit position in an input priority value, and in processing block 314 PM[i] is initialized to zero (i.e. don't care) for each bit position in a priority mask. In processing block 315 a loop index, i, is initialized to one (1).

In processing block 316 the next highest input priority bit P[L-i] and the next highest priority mask bit PM[L-i] are set to one (1) to search for the highest priority matches. Then in processing block 317 the input data string, V, the input mask, VM, the input, priority value, P, and the priority mask, PM, are input as data to search the TCAM. In the TCAM, a number of unsorted data strings and corresponding unsorted priority values are stored at indexed storage locations. If a match is found in processing block 318, the TCAM outputs, as a result of the search, an index for a storage location that stores the matching data string and priority value, and that result is stored in processing block 320. If no match is found in processing block 318 then the input priority bit P[L-i] is changed to zero (0). Then in processing block 321, loop index, i, is incremented to select the next highest input priority bit P[L-i] and the next highest priority mask bit PM[L-i]. The value of loop index, i, is checked in processing block to see that it is still less than or equal to the length, L, of the priority, P, and priority mask, PM, in which case processing continues in processing block 316. Otherwise, the search is complete and processing proceeds to processing block 323 where, if P records a valid priority value indicating that some result from a search has been stored in processing block 320, the last stored search result is output by process 301 as the index for a storage location that stores the matching data string and an optimal priority value. Otherwise no match is returned by process 301.

It will be appreciated that if the number of possible priority values is k−1, then the number of searches required by process 301 is no more than log₂ k. In an alternative embodiment that permits 2^{L} valid priorities (i.e. 0 to 2^{L}−1), then an additional, one initial search may be performed while PM[i] is zero (i.e. don't care) for each bit position in the priority mask, and the number of searches required is no more than log₂ k+1.

Thus process 301 and similar embodiments may provide solutions to priority searches that can be performed in a small number of steps without needing to maintain sorted data in the TCAM storage.

The above description is intended to illustrate preferred embodiments of the present invention. From the discussion above it should also be apparent that especially in such an area of technology, where growth is fast and further advancements are not easily foreseen, the invention-may be modified in arrangement and detail by those skilled in the art without departing from the principles of the present invention within the scope of the accompanying claims and their equivalents.

What is claimed is:

1. A method implemented by one or more machines, said method comprising:
storing a plurality of data strings and corresponding priority values at a corresponding plurality of indexed storage locations in a ternary content-addressable memory (TCAM) wherein the priority values for the corresponding data strings are unsorted with respect to the indices of the corresponding plurality of indexed storage locations;
searching the TCAM using one or more input data each of said one or more input data including a first input string, a first input mask, an input priority value and a priority mask, wherein the number of searches using said one or more input data is no more than the number of valid distinct priority values, k, which is less than the number of indexed storage locations; and
determining when a match index corresponding to an indexed storage location of the plurality of indexed storage locations that stores a data string of the plurality of data strings that matches a portion of the first input string being selected according to the first input mask also corresponds to an indexed storage location that stores an optimal priority value; and
outputting the match index responsive to an affirmative determination.

2. The method of claim 1 wherein the number of searches using said one or more input data is no more than log₂ (k+1).

3. The method of claim 1 wherein the number of searches using said one or more input data is no more than log₂ k+1.

4. The method of claim 1 wherein searching the TCAM using one or more input data comprises a binary search.

5. The method of claim 1 wherein searching the TCAM using one or more input data comprises a linear search.

6. The method of claim 1 wherein searching the TCAM using one or more input data comprises a hybrid combination of a linear search and a binary search.

7. A tangible machine readable medium for implementing the method of claim 1, the medium having stored therein instructions that, when accessed by said one or more machines, cause the one or more machines to implement the method of claim 1.

8. An apparatus comprising:
a TCAM to store a plurality of unsorted data strings and corresponding unsorted priority values at a corresponding plurality of indexed storage locations, the priority values and the corresponding data strings being unsorted with respect to the indices of the corresponding plurality of indexed storage locations;
a search engine to search the TCAM using one or more input data each of said one or more input data including a first input string, a first input mask, an input priority value and a priority mask, wherein the number of searches using said one or more input data is no more than the number of valid distinct priority values, k, which is less than the number of indexed storage locations;
said search engine to determine when a match index corresponding to an indexed storage location of the plurality of indexed storage locations that stores a data string of the plurality of data strings that matches a portion of the first input string being selected according to the first input mask, corresponds to an indexed storage location that also stores an optimal priority value, and to output that match index responsive to an affirmative determination.

9. The apparatus of claim 8 wherein the number of searches using said one or more input data is no more than log₂ (k+1).

10. The apparatus of claim 8 wherein the number of searches using said one or more input data is no more than log₂ k+1.

11. The apparatus of claim 8 said search engine comprising:
one or more machines coupled with the TCAM;
a tangible machine readable medium, the medium having stored therein instructions that, when accessed by said one or more machines, cause the one or more machines to search the TCAM using one or more input data and to determine when said match index corresponds to said indexed storage location that also stores said optimal priority value.
